(19) United States
(12) Patent Application Publication
(10) Pub. No.: US 2015/0300512 A1
(43) Pub. Date: Oct. 22, 2015

(54) AERATING BAG

(71) Applicant: Tung-Cheng Chen, Taichung City (TW)

(72) Inventor: Tung-Cheng Chen, Taichung City (TW)

(21) Appl. No.: 14/258,167

(22) Filed: Apr. 22, 2014

(51) Int. Cl. F16K 15/20

(52) U.S. Cl. CPC F16K 15/202; F16K 15/205

(57) ABSTRACT

An aerating bag has a body and a unidirectional nozzle. The body has an upper membrane, a lower membrane, a ventilating duct, an inflatable chamber and a vent segment. The upper membrane has a concaved segment with a middle and two curved ends. The ventilating duct is formed in the body between the concaved segment and the lower membrane. The inflatable chamber is formed in the body between the membranes and the ventilating duct. The vent segment is formed between the membranes, communicates with the inflatable chamber and has an outlet chamber. The unidirectional gas nozzle is mounted in ventilating duct between the inflatable chamber and the outlet chamber and has an upper valve slice and a lower valve slice mounted between the middle and one of the curved ends of the concaved segment. The valve slices are overlapped with each other in a misalignment state.

### BACKGROUND OF THE INVENTION

1. Field of the Invention

The present invention relates to an aerating bag, and more particularly relates to an aerating bag that can improve the air inflation efficiency of the aerating bag.

2. Description of Related Art

With reference to FIGS. 8 and 9A, a conventional aerating bag is used to inflate objects such as insoles of an air cushion shoe, pad protective covers, bike inflatable cushions or sports protectors, and has an inflatable segment 70, a vent segment 80 and a unidirectional gas nozzle 90. The inflatable segment 70 is made of an elastic material such as rubber to store air, is extrudable and has an upper membrane 71, a lower membrane 72 and a concaved segment 73. The upper membrane 71 has a front end, a rear end and a bottom. The lower membrane 72 is connected to the upper membrane 71 to form the closed inflatable 70 and has a top side and a bottom side. The top side of the lower membrane 72 is connected to the bottom of the upper membrane 71. The concaved segment 73 is formed in the upper membrane 71 between the front end and the rear end of the upper membrane 71, faces the top side of the lower membrane 72 to form a gap between the upper membrane 71 and the lower membrane 72. In addition, the concave segment 73 has a middle.

The vent segment 80 is formed on the front end of the upper membrane 71 of the inflatable segment 70, selectively communicates with the inflatable segment 70 and has an outlet 81. The outlet 81 is connected to the bottom side of the lower membrane 72 near the front end of the upper membrane 71. The unidirectional gas nozzle 90 is securely mounted in the gap between the concaved segment 73 and the lower membrane 72 at the middle of the concave segment 73 to enable the vent segment 80 to communicate with the inflatable segment 70 and has two valve slices 91, 92. The valve slices 91, 92 are included an upper valve slice 91 and a lower valve slice 92. The lower valve slice 91 is mounted between and abuts the upper valve slice 91 and the top side of the lower membrane 72. Each one of the valve slices 91, 92 has a shape, an outer periphery, a front end and a rear end. The shapes of the valve slices 91, 92 are the same, the front ends of the valve slices 91, 92 extend into the vent segment 80 and the rear ends of the valve slices 91, 92 extend into the inflatable segment 70. Furthermore, the valve slices 91, 92 are overlapped with each other at the middle of the concave segment 73 to enable the outer periphery of the upper valve slice 91 to align with the outer periphery of the lower valve slice 92.

In use, with reference to FIGS. 9A and 9B, the membranes 71, 72 of the inflatable segment 70 are respectively pressed by two fingers of a user to extrude the inflatable segment 70 to enable air that is stored in the inflatable segment 70 to flow into the vent segment 80 via the unidirectional gas nozzle 90. However, when the inflatable segment 70 is extruded by the user's fingers, the rear ends of the valve slices 91, 92 may be pressed with the deformation of the membranes 71, 72. Then, the rear ends of the valve slices 91, 92 cannot be open to enable air to flow into the vent segment 80, and this means the rear ends of the valve slices 91, 92 cannot be open to form an interval to enable air to flow into the vent segment 80 because the deformation of the membranes 71, 72 of the inflatable segment 70. Therefore, air that is stored in the inflatable segment 70 cannot be successfully flowed into the vent segment 80 when the user presses and extrudes the inflatable segment 70, and this means the user needs to press and extrude the inflatable segment 70 of the conventional aerating bag many times to achieve an air inflation effect and this will significantly reduce the air inflation efficiency of the conventional aerating bag.

Therefore, the present invention provides an aerating bag to mitigate or obviate the aforementioned problems.

### SUMMARY OF THE INVENTION

The main objective of the present invention is to provide an aerating bag that can improve the air inflation efficiency of the aerating bag.

The aerating bag in accordance with the present invention has a body and a unidirectional nozzle. The body has an upper membrane, a lower membrane, a ventilating duct, an inflatable chamber and a vent segment. The upper membrane has a concaved segment. The concaved segment has a middle and two curved ends. The lower membrane is connected to the upper membrane. The ventilating duct is formed in the body between the concaved segment and the lower membrane. The inflatable chamber is formed in the body between the membranes and the ventilating duct. The vent segment is formed between the membranes, communicates with the inflatable chamber via the ventilating duct and has an outlet chamber. The unidirectional gas nozzle is mounted in ventilating duct between the inflatable chamber and the outlet chamber and has an upper valve slice and a lower valve slice mounted between the middle and one of the curved ends of the concaved segment. The valve slices are overlapped with each other in a misalignment state.

Other objectives, advantages and novel features of the invention will become more apparent from the following detailed description when taken in conjunction with the accompanying drawings.

### BRIEF DESCRIPTION OF THE DRAWINGS

FIG. 1 is a bottom perspective view of a first embodiment of an aerating bag in accordance with the present invention;

FIG. 2 is a bottom side view of the aerating bag in FIG. 1;

FIG. 3A is a side view in partial section of the aerating bag along line 3A-3A in FIG. 2;

FIG. 3B is an enlarged side view in partial section of the aerating bag in FIG. 3A;

FIG. 3C is another enlarged side view in partial section of the aerating bag in FIG. 3A;

FIG. 4 is an inflatable-operational side view in partial section of the aerating bag in FIG. 1;

FIG. 5 is an enlarged inflatable-operational side view in partial section of the aerating bag alone line 5-5 in FIG. 2;

FIG. 6 is an enlarged discharging-operational side view in partial section of the aerating bag in FIG. 1;

FIG. 7 is a bottom perspective view of a second embodiment of an aerating bag in accordance with the present invention;

FIG. 8 is a bottom perspective view of an aerating bag in accordance with the prior art;

FIG. 9A is an inflatable-operational side view in partial section of the aerating bag in FIG. 8; and

FIG. 9B is an enlarged inflatable-operational side view in partial section of the aerating bag in FIG. 9A.

### DETAILED DESCRIPTION OF THE PREFERRED EMBODIMENT

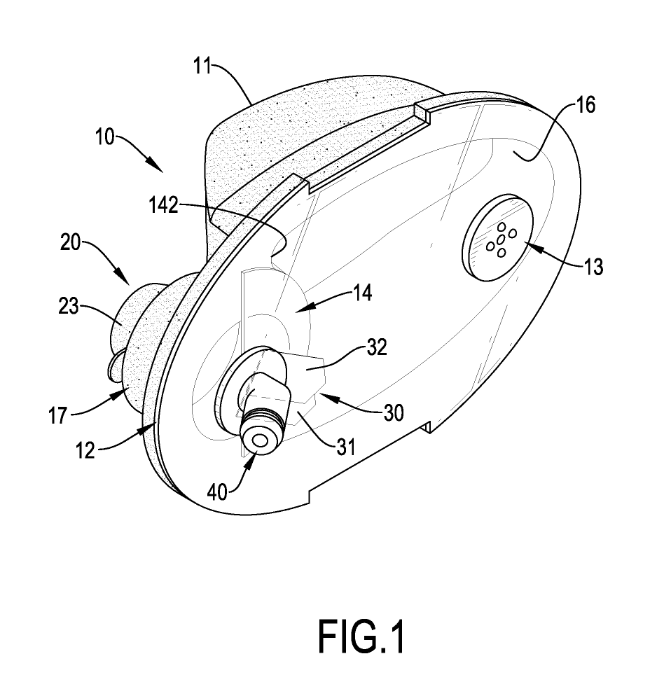

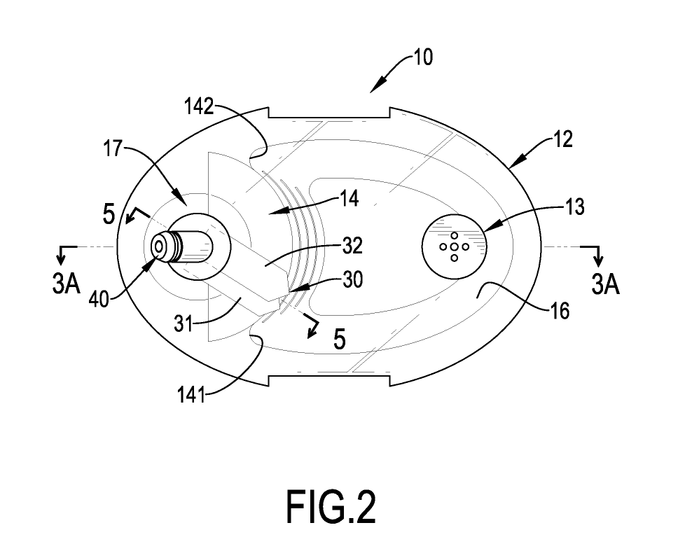

With reference to FIGS. 1, 2 and 3A to 3C, a first embodiment of an aerating bag in accordance with the present invention has a body 10, controlling device 20, a unidirectional gas nozzle 30 and an outlet 40.

The body 10 is compressible and has an upper membrane 11, a lower membrane 12, a ventilating duct 15, an inflatable chamber 16, a vent segment 17 and an intake valve 13. The upper membrane 11 may be made of an elastic material such as rubber and has a front end, a rear end, a bottom, an outer periphery and a concaved segment 14. The concaved segment 14 is formed in the upper membrane 11 between the front end and the rear end of the upper membrane 11 and has a bottom face, a middle, a first curved end 141 and a second curved end 142. The curved ends 141, 142 of the concaved segment 14 are defined away the middle of the concaved segment 14.

The lower membrane 12 may be made of plastic, is connected to the upper membrane 11 to form the closed body 10 and has a front end, a rear end, a top, a bottom, an outer periphery and a communicating hole 121. The top of the lower membrane 12 at the periphery of the lower membrane 12 is securely connected to the bottom of the upper membrane 11 at the periphery of the upper membrane 11 to enable the bottom face of the concaved segment 14 to face the top of the lower membrane 12. The communicating hole 121 is formed through the bottom and the top of the lower membrane 12 near the front end of the lower membrane 12.

The ventilating duct 15 is formed in the body 10 between the concaved segment 14 of the upper membrane 11 and the top of the lower membrane 12. The inflatable chamber 16 is formed in the body 10 between the rear ends of the membranes 11, 12 and the ventilating duct 15 to store air. The vent segment 17 is formed between the front ends of the membranes 11, 12, communicates with the inflatable chamber 16 via the ventilating duct 15 and selectively communicates with the communicating hole 121 of the lower membrane 12.

The vent segment 17 has a vent mount 171 and a separating board 173. The vent mount 171 is formed on the front end of the upper membrane 11, is formed with the concaved segment 14 and is mounted on the top of the lower membrane 12 at the front end of the lower membrane 12. In addition, the vent mount 171 may be tubular and has an open top, an internal surface and an outlet chamber 175. The outlet chamber 175 is formed in the vent mount 171, communicates the inflatable chamber 16 via the ventilating duct 15 and communicates with the communicating hole 121 of the lower membrane 12. The separating board 173 is formed on and protrudes from the internal surface of the vent mount 171 below the open top of the vent mount 171 and has a top side, a bottom side and a through hole. The through hole is formed through the top side and the bottom side of the separating board 173 and communicates with the open top and the outlet chamber 175 of the vent mount 171.

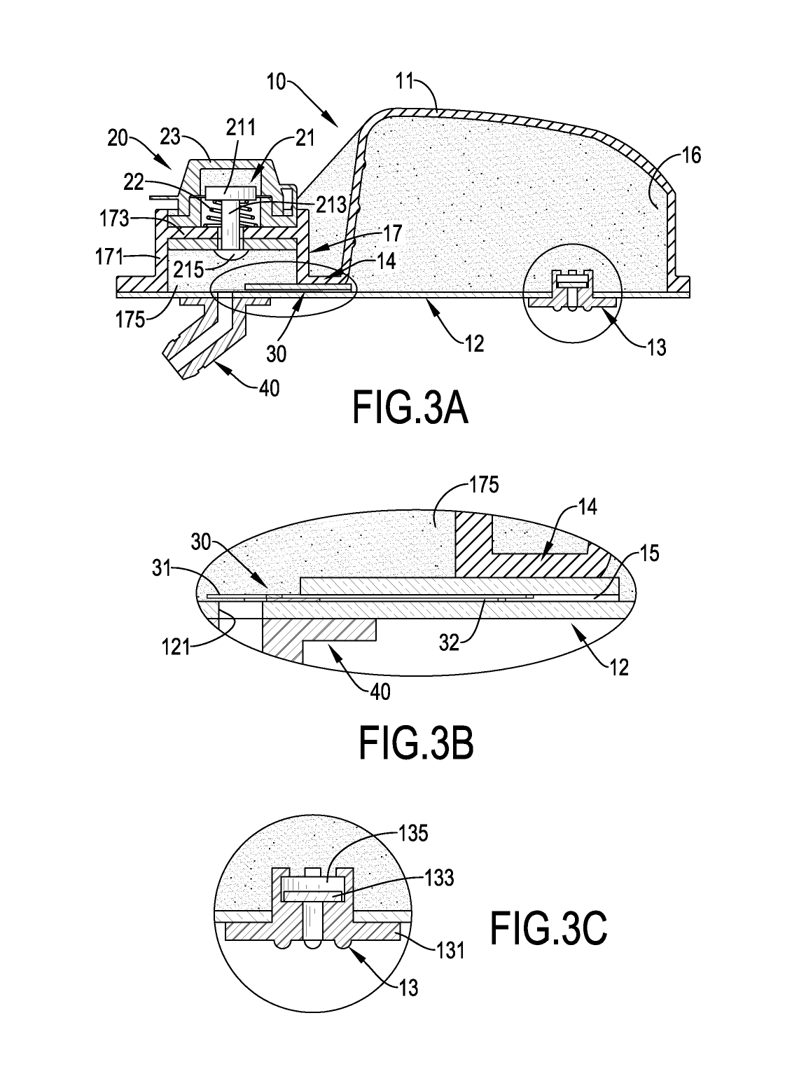

With further reference to FIG. 3C, the intake valve 13 is securely mounted on the bottom of the lower membrane 12 near the rear end of the lower membrane 12 and has a holding mount 131 and a sealing slice 133. The holding mount 131 is securely connected to lower membrane 12 near the rear end of the lower membrane 12, extends into the inflatable chamber 16 and has an outer bottom, an inner top, a mounting recess 135 and an inlet channel. The outer bottom of the holding mount 131 abuts the bottom of the lower membrane 12. The inner top of the holding mount 131 extends into the inflatable chamber 16 of the body 10. The mounting recess 135 is formed in the holding mount 131 near the inner top of the holding mount 131, communicates with the inflatable chamber 16 and has a diameter. The inlet channel is formed through the outer bottom of the holding mount 131, communicates with the mounting recess 135 and has a diameter smaller than the diameter of the mounting recess 135.

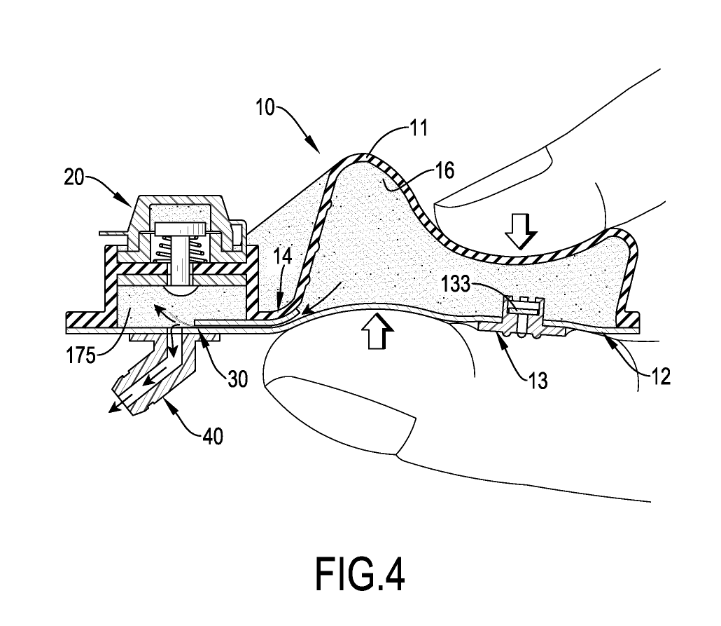

The sealing slice 133 is movably mounted in the mounting recess 135 of the holding mount 131, is held in the mounting recess 135 by the inner top of the holding mount 131 without separating from the holding mount 131 and has a diameter. The diameter of the sealing slice 133 is larger than the diameter of the inlet channel of the holding mount 131 and is smaller than the diameter of the mounting recess 135. With reference to FIG. 4, when the inflatable chamber 16 is extruded by a user's fingers pressing the membranes 11, 12, the air will enable the sealing slice 133 to close the inlet channel of the holding mount 131 to prevent the air from flowing out of the inflatable chamber 16 via the holding mount 131. In addition, the inflatable chamber 16 is set in the vacuum state after the user's fingers pressing the membranes 11, 12. When the user removes the fingers from the membranes 11, 12 to enable the membranes 11, 12 to return the original positions, and outside air will flow into the inflatable chamber 16 via the inlet channel and the mounting recess 135 by the sealing slice 133 is moved relative to the holding mount 131 to enable the inlet channel to communicate with the mounting recess 135.

The controlling device 20 is connected to the body 10 and has a bottom, a top, an external surface, a control valve 21, a spring 22 and a cover 23. The bottom of the controlling device 20 is mounted in the vent mount 171 of the vent segment 17 of the body 10 and is connected to the separating board 173. The top of the controlling device 20 extends out of the open top of the vent mount 171.

The control valve 21 is made of metal, is movably mounted in the controlling device 20 and has a rod 213, a pressing tab 211 and a holding head 215. The rod 213 is movably mounted in the controlling device 20, extends into the outlet chamber 175 via the separating board 173 and has a bottom end and a top end. The bottom end of the rod 213 extends into the outlet chamber 175 via the through hole of the separating board 173. The top end of the rod 213 extends in the top of the controlling device 20. The pressing tab 211 is formed on and protrudes from the top end of the rod 213 and extends out of the top of the controlling device 20. The holding head 215 is formed on and protrudes from the bottom end of the rod 213 and is selectively pressed against the bottom of the controlling device 20 to hold the control valve 21 with the controlling device 20.

The spring 22 is mounted around the rod 213 of the control valve 21 and is pressed against the pressing tab 211 and the separating board 173 to enable the holding head 215 to press against the bottom of the controlling device 20 to prevent the through hole of the separating board 173 from communicating with the outlet chamber 175. The cover 23 is made of plastic and is formed on and protrudes from the external surface of the controlling device 20 near the top of the controlling device 20 to mount in the top of the controlling device 20 to close the control valve 21.

The unidirectional gas nozzle 30 is mounted in ventilating duct 15 of the body 10 between the inflatable chamber 16 and the outlet chamber 175 of the vent segment 17 and has two valve slices 31, 32 mounted between the middle and one of the curved ends 141, 142 of the concaved segment 14. The valve slices 31, 32 include an upper valve slice 31 and a lower valve slice 32, and each one of the valve slices 31, 32 has a shape, an outer periphery, a front end and a rear end. The shapes of the valve slices 31, 32 are the same. The front ends of the valve slices 31, 32 may be rectangular and extend into the outlet chamber 175 of the vent segment 17. In addition, the front end of one of the valve slices 31, 32 is mounted over the communicating hole 121 of the lower membrane 12. The rear ends of the valve slices 31, 32 may be triangular and extend into the ventilating duct 15. Furthermore, the valve slices 31, 32 are overlapped with each other in a misalignment state to enable the front end, the rear end and the outer periphery of one of the valve slices 31, 32 to misalign with the front end, the rear end and the outer periphery of one of the other one valve slice 31, 32. In the first embodiment of the aerating bag in accordance with the present invention, the valve slices 31, 32 are mounted between the middle and the first curved end 141 of the concaved segment 14.

The outlet 40 is connected to the body 10, communicates with the outlet chamber 175 of the vent segment 17 and has a connecting end and an inserting end. The connecting end of the outlet 40 is connected to the communicating hole 121 of the lower membrane 12. The inserting end of the outlet 40 is formed with the connecting end of the outlet 40.

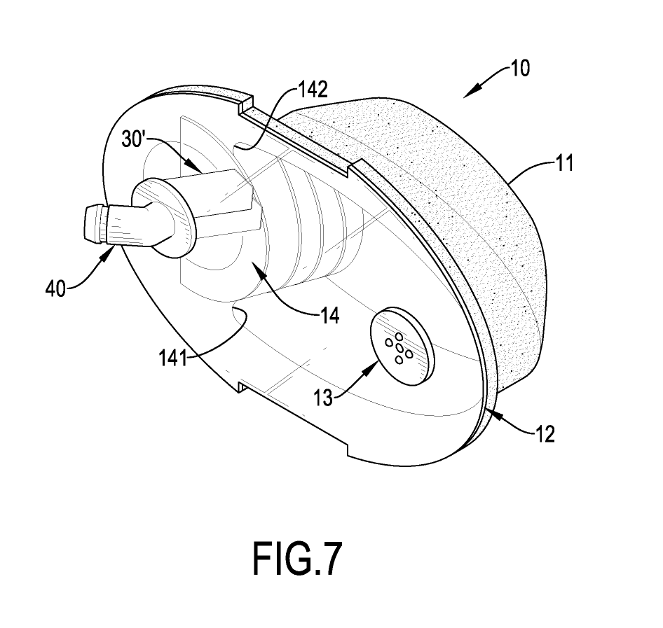

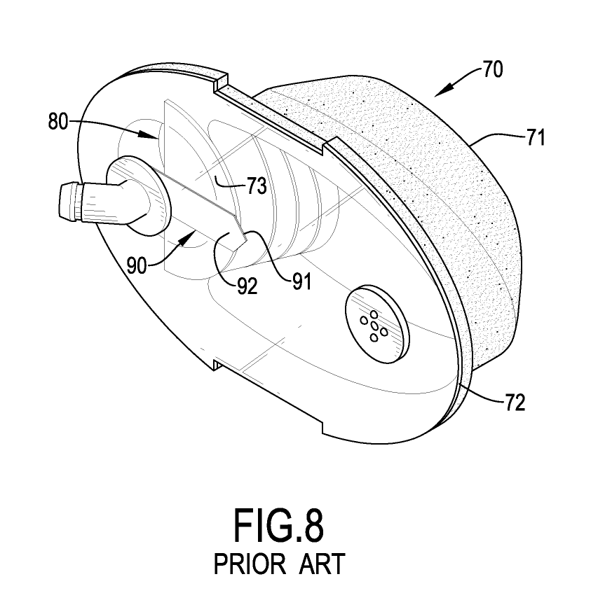

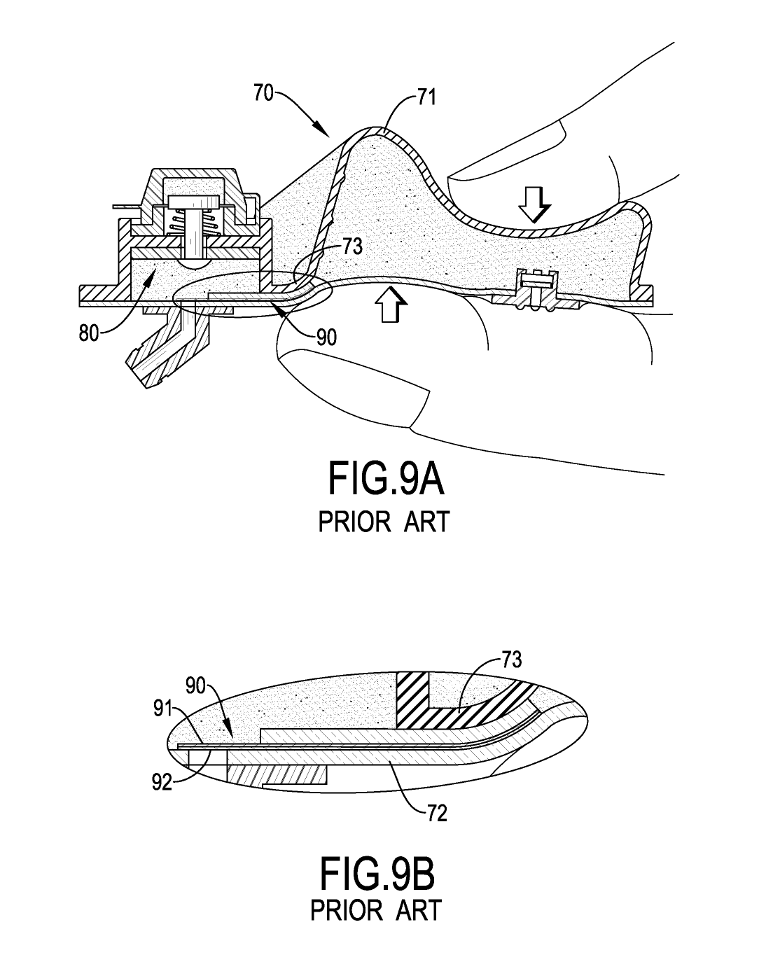

With reference to FIG. 7, a second embodiment of an aerating bag in accordance with the present invention has similar structures substantially the same as the structures in the above-mentioned first embodiment of the aerating bag except the following features. The valve slices 31, 32 of the unidirectional gas nozzle 30′ are mounted between the middle and the second curved end 142 of the concaved segment 14.

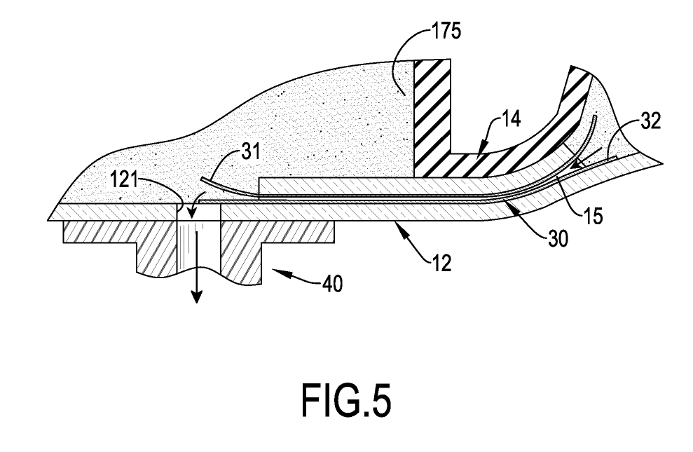

With reference to FIGS. 4 and 5, when using the aerating bag in accordance with the present invention to fill air into an object, putting the inserting end of the outlet 40 into the object and pressing the membranes 11, 12 of the body 10 to let the air in the inflatable chamber 16 to flow into the ventilating duct 15. At the same time, the air will also enable the sealing slice 133 to close the inlet channel of the holding mount 131 to prevent the air from flowing out of the inflatable chamber 16 via the holding mount 131.

Because the valve slices 31, 32 are overlapped with each other in a misalignment state and are mounted between the middle and one of the curved ends 141 of the concaved segment 14. When the membranes 11, 12 of the body 10 is extruded by the user's fingers, the deformation of the membranes 11, 12 at the middle of the concaved segment 14 will not interfere the movement of the valve slices 31, 32. Then, the air can easily and successfully enable the air to separate the rear ends of the valve slices 31, 32 to allow the air passing through the front ends of the valve slices 31, 32. Then, the air can flow into the object via the outlet chamber 175, the communicating hole 121 of the lower membrane 12 and the outlet 40. Furthermore, after the user's fingers pressing the membranes 11, 12, the inflatable chamber 16 is set in the vacuum state and this can make the sealing slice 133 to move upwardly relative to the holding mount to allow the outside air to flow into the inflatable chamber 16 via the inlet channel and the mounting recess 135 when the user removes the fingers from the membranes 11, 12. After the above-mentioned operating cycle, the object can be inflated completely.

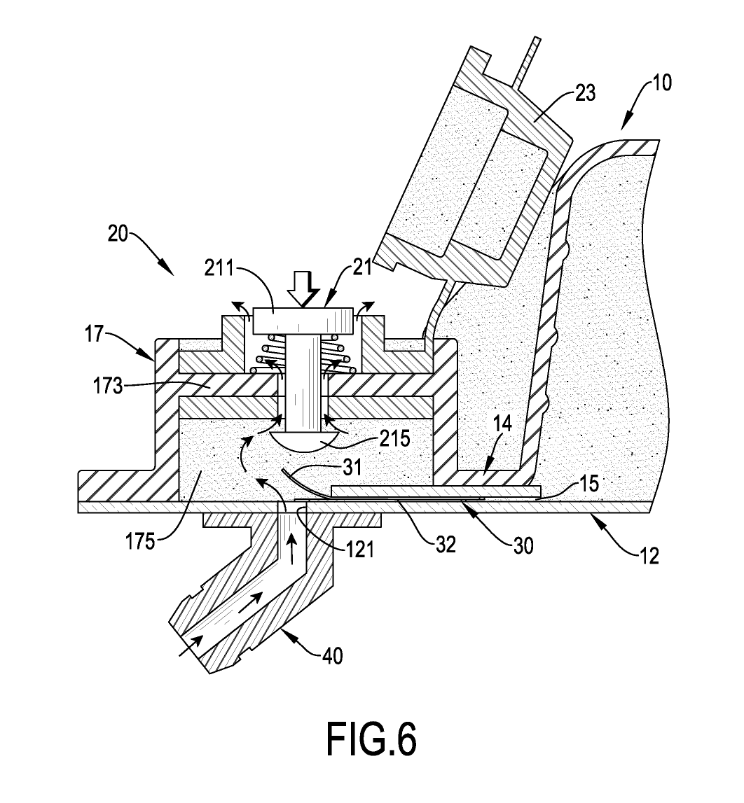

With reference to FIG. 6, when the object is needed to release, the user can open the cover 23 and press the pressing tab 211 of the control valve 21 downwardly to enable the holding head 215 to separate from the bottom of the separating board 173. Then, the air in the object can be flowed out of the object via the outlet 40, the outlet chamber 175, the through hole of the separating board 173 and the open top of the vent mount 171.

According to the above-mentioned features and structural relationships of the aerating bag in accordance with the present invention, first, the valve slices 31, 32 are overlapped with each other in a misalignment state to enable the front end, the rear end and the outer periphery of one of the valve slices 31, 32 to misalign with the front end, the rear end and the outer periphery of one of the other one valve slice 31, 32. Second, the valve slices 31, 32 are mounted between the middle and one of the curved ends 141, 142 of the concaved segment 14 to prevent the valve slices 31, 32 interfering from the deformation of the membranes 11, 12 at the middle of the concaved segment 14 of the body 10. Then, the air in the inflatable chamber 16 can easily and successfully enable the air to separate the rear ends of the valve slices 31, 32 to allow the air passing through the front ends of the valve slices 31, 32 and flow into an object, and this can significantly improve the air inflation efficiency of the aerating bag.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An aerating bag having
a body having
an upper membrane having
a front end;
a rear end;
a bottom;
an outer periphery; and
a concaved segment formed in the upper membrane between the front end and the rear end of the upper membrane and having
a bottom face;
a middle; and
two curved ends being defined away the middle of the concaved segment;
a lower membrane connected to the upper membrane and having
a front end;
a rear end;
an outer periphery;
a top at the periphery of the lower membrane securely connected to the bottom of the upper membrane at the periphery of the upper membrane to enable the bottom face of the concaved segment to face the top of the lower membrane;
a bottom; and
a communicating hole formed through the bottom and the top of the lower membrane near the front end of the lower membrane;
a ventilating duct formed in the body between the concaved segment of the upper membrane and the top of the lower membrane;
an inflatable chamber formed in the body between the rear ends of the membranes and the ventilating duct to store air; and
a vent segment formed between the front ends of the membranes, communicating with the inflatable chamber via the ventilating duct and having an outlet chamber communicating with the communicating hole of the lower membrane; and
a unidirectional gas nozzle mounted in ventilating duct of the body between the inflatable chamber and the outlet chamber of the vent segment and having an upper valve slice and a lower valve slice mounted between the middle and one of the curved ends of the concaved segment, and each one of the valve slices having
a shape being the same as the shape of the other one;
an outer periphery;
a front end extending into the outlet chamber of the vent segment;
a rear end extending into the ventilating duct; and
wherein the valve slices are overlapped with each other in a misalignment state to enable the front end, the rear end and the outer periphery of one of the valve slices to misalign with the front end, the rear end and the outer periphery of one of the other one valve slice.

2. The aerating bag as claimed in claim 1, wherein the aerating bag has an outlet connected to the body, communicating with the outlet chamber of the vent segment, and the outlet has
a connecting end connected to the communicating hole of the lower membrane; and
an inserting end formed with the connecting end of the outlet.

3. The aerating bag as claimed in claim 2, wherein the body of the aerating bag has an intake valve securely mounted on the bottom of the lower membrane near the rear end of the lower membrane, and the intake valve has
a holding mount securely connected to lower membrane near the rear end of the lower membrane, extending into the inflatable chamber and having
an outer bottom abutting the bottom of the lower membrane;
an inner top extending into the inflatable chamber of the body;
a mounting recess formed in the holding mount near the inner top of the holding mount, communicating with the inflatable chamber and having a diameter; and
an inlet channel formed through the outer bottom of the holding mount, communicating with the mounting recess and having a diameter smaller than the diameter of the mounting recess; and
a sealing slice movably mounted in the mounting recess of the holding mount, held in the mounting recess by the inner top of the holding mount and having a diameter larger than the diameter of the inlet channel of the holding mount and smaller than the diameter of the mounting recess.

4. The aerating bag as claimed in claim 1, wherein
the vent segment has
a vent mount formed on the front end of the upper membrane, formed with the concaved segment and mounted on the top of the lower membrane at the front end of the lower membrane and having
an open top; and
an internal surface; and
a separating board formed on and protruding from the internal surface of the vent mount below the open top of the vent mount and having
a top side;
a bottom side; and
a through hole formed through the top side and the bottom side of the separating board and communicating with the open top and the outlet chamber of the vent mount;
the outlet chamber is formed in the vent mount below the separating board; and
the aerating bag has a controlling device connected to the body, and the controlling device has
a bottom mounted in the vent mount of the vent segment of the body and connected to the separating board;
a top extending out of the open top of the vent mount;
an external surface; and
a control valve movably mounted in the controlling device and having a rod movably mounted in the controlling device, extending into the outlet chamber via the separating board and having
a bottom end extending into the outlet chamber via the through hole of the separating board;
a top end extending in the top of the controlling device;
a pressing tab formed on and protruding from the top end of the rod and extending out of the top of the controlling device; and
a holding head formed on and protruding from the bottom end of the rod and selectively pressed against the bottom of the controlling device to hold the control valve with the controlling device.

5. The aerating bag as claimed in claim 2, wherein
the vent segment has
a vent mount formed on the front end of the upper membrane, formed with the concaved segment and mounted on the top of the lower membrane at the front end of the lower membrane and having
an open top; and
an internal surface; and
a separating board formed on and protruding from the internal surface of the vent mount below the open top of the vent mount and having
a top side;
a bottom side; and
a through hole formed through the top side and the bottom side of the separating board and communicating with the open top and the outlet chamber of the vent mount;
the outlet chamber is formed in the vent mount below the separating board; and
the aerating bag has a controlling device connected to the body, and the controlling device has
a bottom mounted in the vent mount of the vent segment of the body and connected to the separating board;
a top extending out of the open top of the vent mount;
an external surface; and
a control valve movably mounted in the controlling device and having a rod movably mounted in the controlling device, extending into the outlet chamber via the separating board and having
a bottom end extending into the outlet chamber via the through hole of the separating board;
a top end extending in the top of the controlling device;
a pressing tab formed on and protruding from the top end of the rod and extending out of the top of the controlling device; and
a holding head formed on and protruding from the bottom end of the rod and selectively pressed against the bottom of the controlling device to hold the control valve with the controlling device.

6. The aerating bag as claimed in claim 3, wherein
the vent segment has
a vent mount formed on the front end of the upper membrane, formed with the concaved segment and mounted on the top of the lower membrane at the front end of the lower membrane and having
an open top; and
an internal surface; and
a separating board formed on and protruding from the internal surface of the vent mount below the open top of the vent mount and having
a top side;
a bottom side; and
a through hole formed through the top side and the bottom side of the separating board and communicating with the open top and the outlet chamber of the vent mount;
the outlet chamber is formed in the vent mount below the separating board; and
the aerating bag has a controlling device connected to the body, and the controlling device has
a bottom mounted in the vent mount of the vent segment of the body and connected to the separating board;
a top extending out of the open top of the vent mount;
an external surface; and
a control valve movably mounted in the controlling device and having a rod movably mounted in the controlling device, extending into the outlet chamber via the separating board and having
a bottom end extending into the outlet chamber via the through hole of the separating board;
a top end extending in the top of the controlling device;
a pressing tab formed on and protruding from the top end of the rod and extending out of the top of the controlling device; and
a holding head formed on and protruding from the bottom end of the rod and selectively pressed against the bottom of the controlling device to hold the control valve with the controlling device.

7. The aerating bag as claimed in claim 4, wherein the controlling device has a spring mounted around the rod of the control valve and pressed against the pressing tab and the separating board to enable the holding head to press against the bottom of the controlling device to prevent the through hole of the separating board from communicating with the outlet chamber.

8. The aerating bag as claimed in claim 5, wherein the controlling device has a spring mounted around the rod of the control valve and pressed against the pressing tab and the separating board to enable the holding head to press against the bottom of the controlling device to prevent the through hole of the separating board from communicating with the outlet chamber.

9. The aerating bag as claimed in claim 6, wherein the controlling device has a spring mounted around the rod of the control valve and pressed against the pressing tab and the separating board to enable the holding head to press against the bottom of the controlling device to prevent the through hole of the separating board from communicating with the outlet chamber.

10. The aerating bag as claimed in claim 7, wherein the controlling device has a cover formed on and protruding from the external surface of the controlling device near the top of the controlling device to mount in the top of the controlling device to close the control valve.

11. The aerating bag as claimed in claim 8, wherein the controlling device has a cover formed on and protruding from the external surface of the controlling device near the top of the controlling device to mount in the top of the controlling device to close the control valve.

12. The aerating bag as claimed in claim 9, wherein the controlling device has a cover formed on and protruding from the external surface of the controlling device near the top of the controlling device to mount in the top of the controlling device to close the control valve.

13. The aerating bag as claimed in claim 1, wherein the body of the aerating bag has an intake valve securely mounted on the bottom of the lower membrane near the rear end of the lower membrane, and the intake valve has
a holding mount securely connected to lower membrane near the rear end of the lower membrane, extending into the inflatable chamber and having
an outer bottom abutting the bottom of the lower membrane;
an inner top extending into the inflatable chamber of the body;
a mounting recess formed in the holding mount near the inner top of the holding mount, communicating with the inflatable chamber and having a diameter; and
an inlet channel formed through the outer bottom of the holding mount, communicating with the mounting recess and having a diameter smaller than the diameter of the mounting recess; and
a sealing slice movably mounted in the mounting recess of the holding mount, held in the mounting recess by the inner top of the holding mount and having a diameter larger than the diameter of the inlet channel of the holding mount and smaller than the diameter of the mounting recess.

14. The aerating bag as claimed in claim 13, wherein
the vent segment has
a vent mount formed on the front end of the upper membrane, formed with the concaved segment and mounted on the top of the lower membrane at the front end of the lower membrane and having
an open top; and
an internal surface; and
a separating board formed on and protruding from the internal surface of the vent mount below the open top of the vent mount and having
a top side;
a bottom side; and
a through hole formed through the top side and the bottom side of the separating board and communicating with the open top and the outlet chamber of the vent mount;
the outlet chamber is formed in the vent mount below the separating board; and
the aerating bag has a controlling device connected to the body, and the controlling device has
a bottom mounted in the vent mount of the vent segment of the body and connected to the separating board;
a top extending out of the open top of the vent mount;
an external surface; and
a control valve movably mounted in the controlling device and having a rod movably mounted in the controlling device, extending into the outlet chamber via the separating board and having
a bottom end extending into the outlet chamber via the through hole of the separating board;
a top end extending in the top of the controlling device;
a pressing tab formed on and protruding from the top end of the rod and extending out of the top of the controlling device; and
a holding head formed on and protruding from the bottom end of the rod and selectively pressed against the bottom of the controlling device to hold the control valve with the controlling device.

15. The aerating bag as claimed in claim 14, wherein the controlling device has a spring mounted around the rod of the control valve and pressed against the pressing tab and the separating board to enable the holding head to press against the bottom of the controlling device to prevent the through hole of the separating board from communicating with the outlet chamber.

16. The aerating bag as claimed in claim 15, wherein controlling device has a cover formed on and protruding from the external surface of the controlling device near the top of the controlling device to mount in the top of the controlling device to close the control valve.
